(19) United States
(12) Patent Application Publication
(10) Pub. No.: US 2006/0209186 A1
(43) Pub. Date: Sep. 21, 2006

(54) Field angle adjustment apparatus, camera system, and field angle adjustment method

(75) Inventors: Tetsuo Iyoda, Kanagawa (JP); Hiroyuki Miyake, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/221,830

(22) Filed: Sep. 9, 2005

(30) Foreign Application Priority Data
Mar. 16, 2005 (JP) 2005-076156

(51) Int. Cl. H04N 7/18

(52) U.S. Cl. 348/142

(57) ABSTRACT

There is provided an apparatus for adjusting a field angle including a pointer device that projects a pattern having a given mark shape in a direction same as a light axis of a pan-tilt-zoom camera, a calculation portion that calculates a relationship between a pixel position in an image of a wide camera and a pan angle and a tilt angle in the pan-tilt-zoom camera on the basis of a detected mark shape in the image captured by the wide camera, and an adjustment portion that adjusts the field angle of the wide camera and that of the pan-tilt-zoom camera with the use of the relationship calculated by the calculation portion.

### BACKGROUND OF THE INVENTION

1. Field of the Invention

This invention relates to an apparatus for adjusting a field angle, camera system, and a method for adjusting the field angle.

2. Description of the Related Art

Video conferencing at remote locations is increasingly becoming widespread. Thanks to the advancements of the Internet and digital cameras and availableness thereof, more and more people are able to communicate with each other in various situations, even located in different places. Conventionally, when a video conferencing is held between two places, video cameras have to be equipped with both places. Most of the video conferencing systems include pan-tilt-zoom (PTZ) cameras. The pan-tilt-zoom camera, in the aforementioned system, is capable of providing a user with a close-up view of a certain point. The user is capable of controlling the pan-tilt-zoom camera with a viewer from a remote location.

Japanese Patent Application Publication No. 2004-64784 (hereinafter, referred to as Document 1) and Japanese Patent Application Publication No. 11-8844 (hereinafter, referred to as Document 2) discloses camera systems as described above. The system described in Document 1 corresponds a zoom image to a wide image in several angle fields and directions for a simple calibration of positioning at the time of installation.

The technique described in Document 1, however, can only calibrate the pan-tilt-zoom camera roughly, whereas the wide camera can be calibrated precisely. The technique described in Document 1 cannot match the relative field angles of the cameras. In simply positioning the images, the position pointed on a wide screen is misaligned with that on a pan-tilt-zoom screen in both field angle and direction. This brings not only discomfort to an operator but also a problem in practical use.

### SUMMARY OF THE INVENTION

The present invention has been made in view of the above circumstances and provides a field angle adjustment apparatus, camera system, and field angle adjustment method, which are capable of calibrating the relative positions in a wide camera screen and in a pan-tilt-zoom camera readily with a sufficient accuracy.

According to one aspect of the present invention, there may be provided an apparatus for adjusting a field angle including a pointer device that projects a pattern having a given mark shape in a direction same as a light axis of a pan-tilt-zoom camera, a calculation portion that calculates a relationship between a pixel position in an image of a wide camera and a pan angle and a tilt angle in the pan-tilt-zoom camera on the basis of a detected mark shape in the image captured by the wide camera, and an adjustment portion that adjusts the field angle of the wide camera and that of the pan-tilt-zoom camera with the use of the relationship calculated by the calculation portion. It is therefore-possible to adjust the relative position of the screen of the wide camera and that of the pan-tilt-zoom camera readily with sufficient accuracy.

According to another aspect of the present invention, there may be provided a camera system including a wide camera, a pan-tilt-zoom camera, and the above-mentioned apparatus for adjusting a field angle.

According to a further aspect of the present invention, a method for adjusting a field angle including projecting a pattern having a given mark shape in a direction same as a light axis of a pan-tilt-zoom camera, obtaining a relationship between a pixel position in an image of a wide camera and a pan angle and a tilt angle in the pan-tilt-zoom camera on the basis of a detected mark shape in the image captured by the wide camera, and adjusting the field angle of the wide camera and that of the pan-tilt-zoom camera with the use of the relationship calculated by the calculation portion. It is possible to adjust the field angles of the wide camera and the pan-tilt-zoom camera appropriately at the time of building up, installing, and moving the cameras.

### BRIEF DESCRIPTION OF THE DRAWINGS

Embodiments of the present invention will be described in detail based on the following figures, wherein:

FIG. 1 is a view showing a camera system embodying the present invention;

FIG. 2 shows an interface 50 that provides a video frame image having multiple resolutions;

FIGS. 3A and 3B are views illustrating a process of field angle adjustment in the camera system; and

FIG. 4 is a flowchart showing the process of the filed angle adjustment in the camera system.

### DESCRIPTION OF THE EMBODIMENTS

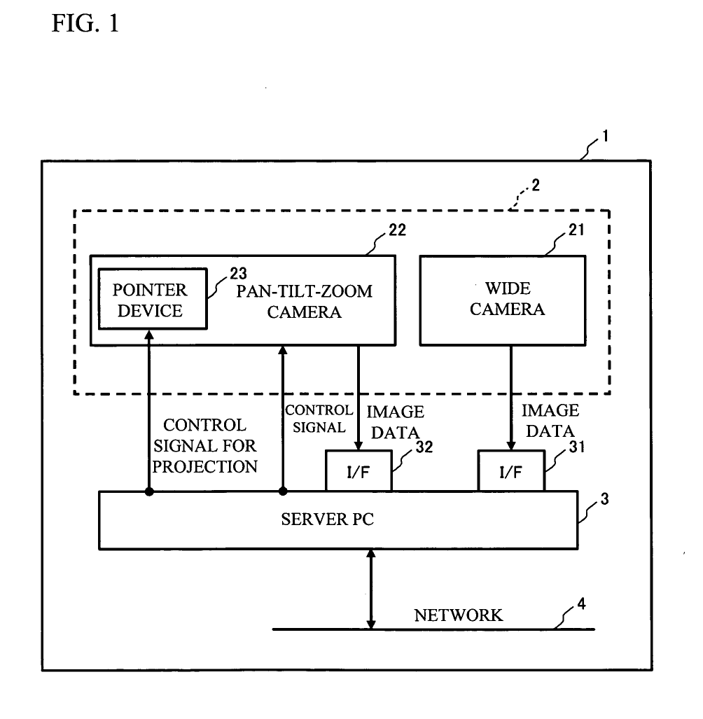

A description will now be given, with reference to the accompanying drawings, of embodiments of the present invention. FIG. 1 is a view showing a camera system embodying the present invention. As shown in FIG. 1, a camera system 1 includes a camera 2 and a server 3. The camera 2 includes a wide camera 21 and a pan-tilt-zoom camera 22. The wide camera 21 is an arbitrary camera that captures video frames. The wide camera 21 is made up of multiple wide-angle cameras or a single panorama camera. The video frames that have been captured with the aforementioned multiple wide-angle cameras are put together to generate a panoramic image. For example, with two wide-angle cameras, it is possible to obtain the image frame having approximately 100 degrees of angular range of the view and a resolution of 1,200×480.

The pan-tilt-zoom camera 22 is capable of performing pan, tilt, and zoom operations in response to a control signal applied from the server 3. The pan-tilt-zoom camera 22 is as represented by, for example, Sony EVI-D30 PTZ camera. The pan-tilt-zoom camera 22 is capable of providing an image having a resolution of 768×492 and is capable of zooming up to an angular range of view of 4.4 degrees. The wide camera 21 and the pan-tilt-zoom camera 22 are adjacently arranged to each other, and substantially face an identical direction. Also, the wide camera 21 and the pan-tilt-zoom camera 22 are aligned with each other. This makes it possible to make the pan-tilt-zoom camera 22 face X-coordinate and Y-coordinate obtained from a view of the wide camera 21. However, unless the filed angle is adjusted, the image captured by the wide camera 21 and that captured by the pan-tilt-zoom camera 22 are largely misaligned in both the filed angle and direction. This brings not only discomfort to the operator but also the problem in practical use.

In addition, the pan-tilt-zoom camera 22 is equipped with a pointer device 23. The pointer device 23 is provided for projecting a pointer for adjusting the field angle of the wide camera 21 and the pan-tilt-zoom camera 22. The pointer device 23 projects a pattern having a characteristic, namely, a given mark shape in a direction equal to a light axis of the pan-tilt-zoom camera 22. Further, the pan-tilt-zoom camera 22 is also equipped with a hot shoe device so that a simple pointer device can be mounted for projecting the pointer in the direction equal to the light axis of the camera. The simple pointer device may be mounted only when the field angle is adjusted.

The server 3 controls the whole camera system 1, and may be a single server or may be provided individually or separately. The server 3 is capable of communicating remotely by way of the network 4. The network 4 may be a wide area network (WAN) including the Internet or a local area network (LAN).

The server 3 transmits a control signal so as to sequentially move a pan angle or tilt angle of the pan-tilt-zoom camera 22 according to a direction set prepared in advance. The server 3 detects a mark shape in the image that has been captured by the wide camera 21, and calculates the relationship between a pixel position in the image of the wide camera 21 and the pan and tile angles of the pan-tilt-zoom camera 22. More specifically, the server 3 calculates the relationship between the pixel position in the image of the wide camera 21 and the pan and tile angles of the pan-tilt-zoom camera 22, with the use of combinations of information on the pan and tilt angles sequentially moved according to the direction set and the information on the pixel position of the image in the wide camera 21. Then, the server 3 uses the combinations of the information on the pan angle, the tilt angle, and the information on the pixel position of the image in the wide camera 21, and adjusts the field angles in the wide camera 21 and the pan-tilt-zoom camera 22.

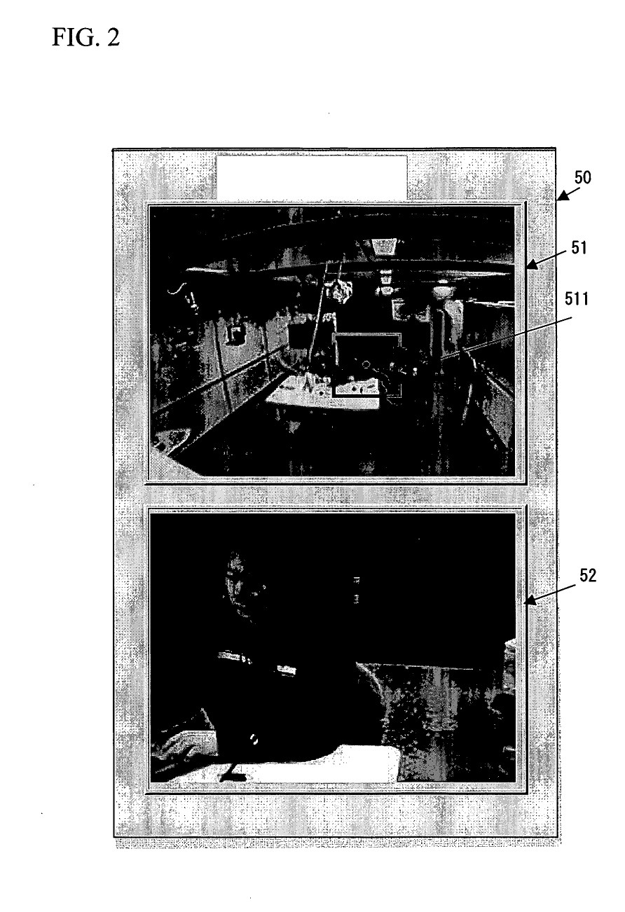

FIG. 2 shows an interface 50 that provides a video frame image having multiple resolutions. The interface 50 includes a landscape window 51 and a close-up window 52. The landscape window 51 provides the user with an overview video image captured by the wide camera 21. The close-up window 52 provides the user with a close-up image captured by the pan-tilt-zoom camera 22. The close-up image displayed on the close-up window 52 partially corresponds to the image displayed on the landscape window 51. Here, the landscape window 51 displays the image in the conference room. So, the close-up window 52 displays a portion of the image in the conference room. The content of the close-up image can be selected automatically by a multi-resolution video system or on the basis of the user's input.

A box 511 of the landscape window 51, shown by a white frame, shows a portion of a landscape window image that corresponds to the close-up window image. For example, the size and position of the box 511 correspond to the user's input. The user may select an area for the landscape window 51 with an input device.

Next, a description will be given of the camera system 1. The wide camera 21 captures an image and transmits the image data to the server 3 via an interface 31. The server 3 receives the image captured by the wide camera 21 by way of the interface 31, and transmits the image to the network 4. The server 3 receives the control signal from the user and an automatic control unit through the network 4. The server 3 processes the control signal and sends the control signal to the pan-tilt-zoom camera 22.

The server 3 gives instructions of pan, tilt, zoom, and other functions of the pan-tilt-zoom camera 22 to capture an image corresponding to an area of a panoramic image. The pan-tilt-zoom camera 22 receives the control signal from the server 3, captures the image, and provides the image data to the server 3 via an interface 32. The server 3 provides the user and the automatic control unit with the image of the pan-tilt-zoom camera 22 through the network 4. The image captured by the wide camera 21 and that captured by the pan-tilt-zoom camera 22 may be recorded in a memory cache on the server 3 or in another memory source, not shown.

The user and the automatic control unit receive the video image through the network 4, and supply the input to the automatic control unit and the server 3 through the network 4. The camera system 1 provides the user with the video image having multiple resolutions, by providing the video frame images from the wide camera 21 and the pan-tilt-zoom camera 22.

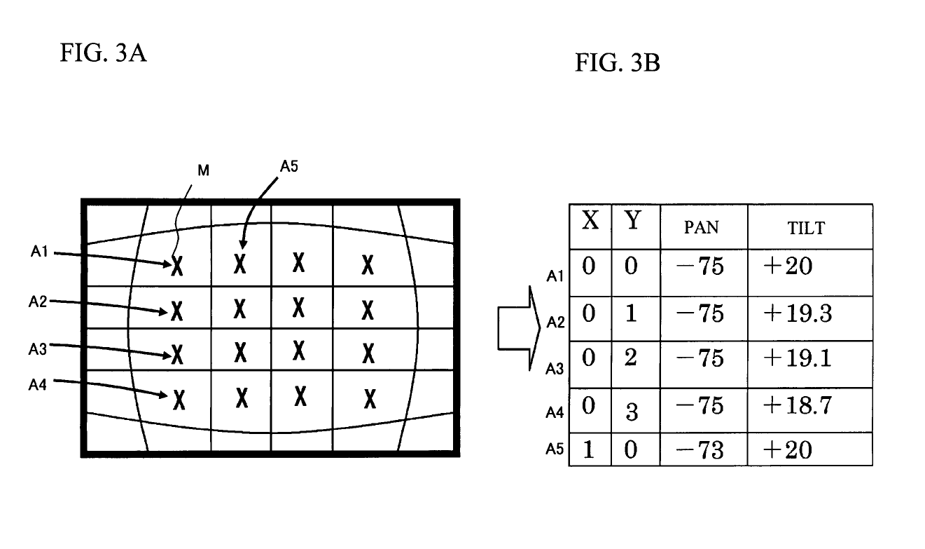

Next, a description will be given of a process of adjusting the field angle in the camera system 1. FIGS. 3A and 3B are views illustrating the process of the field angle adjustment in the camera system 1. FIG. 3A shows data captured by the wide camera 21. In FIG. 3A, “X” denotes a mark M projected by the pointer device 23. The pan angle and tilt angle of the pan-tilt-zoom camera 22 are sequentially moved according to the direction set prepared in advance, for example, from A1 to A5. The characteristic mark shape M, which is shown in the image of the wide camera 21, is detected in each angle, and the relative correspondence of the positional relationship in the image captured by the wide camera 21 is calculated.

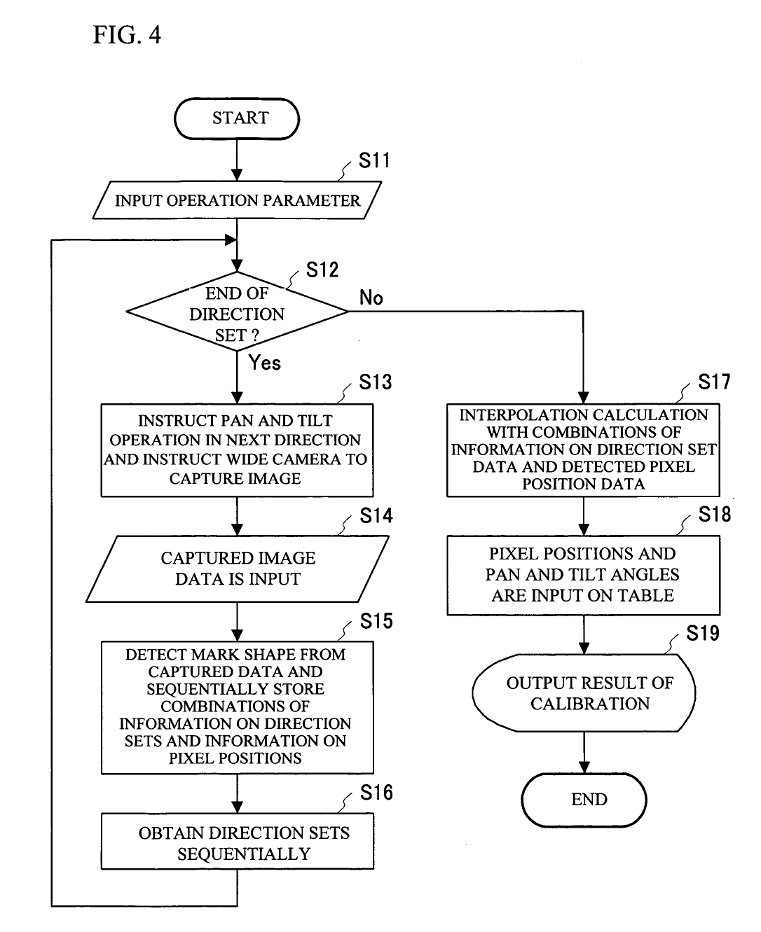

By applying the aforementioned procedure to the whole direction set, the information on an angle set including the pan angle (Pan) and the tilt angle (Tilt) is obtained. By using the combinations of the information on the angle set and the information on the pixel positions (X, Y) of the image in the wide camera 21, the relationship between an arbitrary pixel position in the image of the wide camera and the pan angle (Pan) and the tilt angle (Tilt) is obtained by an interpolation calculation. Light axes of the wide camera and the pan-tilt-zoom camera are deviated when the cameras are built up for installation or movement. It is therefore desirable to adjust the field angle once again according to the purpose of the present invention so that the error variance may be readjusted in the relationship between the pan and tilt angles and the pixel position in the wide camera 21, in view of the relationship with the target to be captured. In this manner, a table, which shows the relationship between the pan and tilt angles and the pixel position in the wide camera 21, is obtainable, as shown in FIG. 3B. This table is incorporated into control software installed on the server 3 for adjusting the field angle. This makes it possible to calculate accurate pan and tile angles when a client terminal instructs a pan-tilt-zoom operation to a specific position on the image shown in the wide camera. Now, a description will be given of the aforementioned procedure, with reference to FIG. 4.

FIG. 4 is a flowchart showing the process of the filed angle adjustment in the camera system 1. An operation parameter is input into the server 3 in step S11. The server 3 transmits the control signal to the pan-tilt-zoom camera 22, and sequentially moves the pan angle and tilt angle of the pan-tilt-zoom camera 22 according to the direction set prepared in advance. Also, the server 3 transmits the control signal for projecting the pointer to the pointer device 23. The pointer device 23 projects the pattern having a characteristic mark shape in a direction same as the light axis of the pan-tilt-zoom camera 22, according to the control signal for projecting the pointer applied from the server 3.

If the direction set does not represent an end in step S12, the server 3 goes to step S13. The server 3 transmits the control signal to the pan-tilt-zoom camera 22 to give instructions of the pan-tilt operation to the next direction, and in addition, gives an instruction of capturing the image on that position in step S13. The data captured by the wide camera 21, as shown in FIG. 3A, is input into the server 3 through the interface 31 in step S14. The server 3 performs the detection process of the characteristic mark shape M on the basis of the data captured by the wide camera 21, and calculates the relative correspondence of the positional relationship in the image in the wide camera 21.

Here, the calculation of the relative correspondence of the positional relationship denotes that the mark position in the wide camera 21 is detected by the image processing to store a combination of the positional coordinates in the wide camera 21 and the pan and tilt angles in the direction set. The combination is stored as one row on the corresponding table. By repeating the aforementioned operations, obtained is only a combination table of over ten of the pan and tilt angles in the wide camera 21 and the positional coordinates in the wide camera 21. Therefore, it is configured that in between the values in the direction set are filled by the interpolation calculation. Further, the server 3 sequentially stores the information on the combination of the data of the direction set and that of the detected pixel positions having the characteristic mark shape. The server 3 sequentially obtains the direction set in step S16.

If the direction set represents an end in step S12, the server 3 calculates the relationship between an arbitrary pixel position of the image in the wide camera 21 and the pan and tilt angles of the pan-tilt-zoom camera 22 with the interpolation calculation, by using the combinations of the information on the angle set (the data of the direction set) and the information on the pixel position (the data of the detected pixel position), in step S17. That is to say, FIG. 3B schematically shows cases where X=0, 1, . . . , Y=0, 1, 2, 3 . . . . However, in fact, for example, if the number of pixels is approximately 1,500×1,000, X=210, 625, 1080, 1520, and Y=180, 395, 610, and 820.

The instruction on the pan-tilt-zoom operation to a specific position in the image of the wide camera 21 is given as the data of the pixel position of the wide camera 21, for example (X, Y)=(385, 550). In this case, the corresponding pan and tilt angles cannot be calculated with the above-mentioned table only. Besides, if the interpolation calculation is performed in each case, it requires time. Preferably, the pan and tilt angles corresponding to all the pixels in the wide camera 21 are configured to be calculated at the time of calibration. If the pan and tilt angles have values obviously continuing, it is readily perform the interpolation calculation to fill the values between the pan and tilt angles. Here, the pan and tilt angles having values obviously continuing means that the deviation characteristics are obviously something like polynomial function. A known method for interpolation calculation is applicable to the aforementioned functional relationship. The method for interpolation calculation can be represented by the polynomial function, for example, (Pan, Tilt)=F (X, Y).

The server 3 displays the relationship between the pixel positions and the pan and tilt angles in a table in step S18, and obtains the data set in the table as shown in FIG. 3B, as a result of the process of the relationship between the pixel positions and the pan and tilt angles. The server 3 outputs the result of the data set in step S19. By incorporating the results of the data set into the control software as a result of simple calibration procedure at the time of assembling, installation, and move, the relative positions between the display of the wide camera 21 and that of the pan-tilt-zoom camera 22 can be calibrated readily with a sufficient accuracy.

The apparatus for adjusting the field angle in the above-mentioned aspect may further include a transmission portion that transmits a control signal to sequentially move the pan angle and the tilt angle according to direction set prepared in advance. The calculation portion may obtain the pan angle and the tilt angle when the pan-tilt-zoom camera is moved according to the direction set and the pixel position in the image of the wide camera, performs an interpolation calculation with the use of combinations of information on the pan angle and the tilt angle and the information on the pixel position in the image of the wide camera, and calculates the relationship between the pan angle and the tilt angle and the pixel position in the image of the wide camera.

The method for adjusting the field angle in accordance with the present invention is realized with a CPU (Central Processing Unit), ROM (Read Only Memory), RAM (Random Access Memory), and the like, by installing a program from a portable memory device or a storage device such as a hard disc device, CD-ROM, DVD, or a flexible disc or downloading the program through a communications line. Then the steps of program are executed as the CPU operates the program.

Although a few embodiments of the present invention have been shown and described, it would be appreciated by those skilled in the art that changes may be made in these embodiments without departing from the principles and spirit of the invention, the scope of which is defined in the claims and their equivalents.

The entire disclosure of Japanese Patent Application No. 2005-076156 filed on Mar. 16, 2005 including specification, claims, drawings, and abstract is incorporated herein by reference in its entirety.

What is claimed is:

1. An apparatus for adjusting a field angle comprising:
a pointer device that projects a pattern having a given mark shape in a direction same as a light axis of a pan-tilt-zoom camera;
a calculation portion that calculates a relationship between a pixel position in an image of a wide camera and a pan angle and a tilt angle in the pan-tilt-zoom camera on the basis of a detected mark shape in the image captured by the wide camera; and
an adjustment portion that adjusts the field angle of the wide camera and that of the pan-tilt-zoom camera with the use of the relationship calculated by the calculation portion.

2. The apparatus for adjusting the field angle according to claim 1, further comprising a transmission portion that transmits a control signal to sequentially move the pan angle and the tilt angle according to direction set prepared in advance,
wherein the calculation portion obtains the pan angle and the tilt angle by sequentially moving the pan-tilt-zoom camera according to the direction set and the pixel position in the image of the wide camera, performs an interpolation calculation with the use of combinations of information on the pan angle and the tilt angle and the information on the pixel position in the image of the wide camera, and calculates the relationship between the pan angle and the tilt angle and the pixel position in the image of the wide camera.

3. A camera system comprising:
a wide camera;
a pan-tilt-zoom camera; and
an apparatus for adjusting a field angle,
the apparatus for adjusting a field angle including
a pointer device that projects a pattern having a given mark shape in a direction same as a light axis of the pan-tilt-zoom camera;
a calculation portion that calculates a relationship between a pixel position in an image of the wide camera and a pan angle and a tilt angle in the pan-tilt-zoom camera on the basis of a detected mark shape in the image captured by the wide camera; and
an adjustment portion that adjusts the field angle of the wide camera and that of the pan-tilt-zoom camera with the use of the relationship calculated by the calculation portion.

4. A method for adjusting a field angle comprising:
projecting a pattern having a given mark shape in a direction same as a light axis of a pan-tilt-zoom camera;
obtaining a relationship between a pixel position in an image of a wide camera and a pan angle and a tilt angle in the pan-tilt-zoom camera on the basis of a detected mark shape in the image captured by the wide camera; and
adjusting the field angle of the wide camera and that of the pan-tilt-zoom camera with the use of the relationship calculated by the calculation portion.

5. The method for adjusting a field angle according to claim 4, further comprising transmitting a control signal to sequentially move the pan angle and the tilt angle according to direction set prepared in advance.
